(19) United States
(12) Patent Application Publication
(10) Pub. No.: US 2001/0052494 A1
(43) Pub. Date: Dec. 20, 2001

(54) Chemical cleaning backwash for normally immersed membranes

(76) Inventors: Pierre Cote, Dundas (CA); Hamid Rabie, Mississauga (CA); Nicholas Adams, Hamilton (CA); Hidayat Husain, Brampton (CA); Henry Behmann, Puslinch (CA); Steven Pedersen, Burlington (CA); Jason Cadera, Guelph (CA)

Correspondence Address: Scott R. Pundsack, Bereskin & Parr, Box 401, 40 King Street West, Toronto, ON, M5H 3Y2, CA

(21) Appl. No.: 09/916,247

(22) Filed: Jul. 30, 2001

Related U.S. Application Data
(63) Continuation-in-part of application No. 09/425,234, filed on Oct. 25, 1999.

(51) Int. Cl. B01D 65/02

(52) U.S. Cl. 210/636; 210/785; 210/797; 210/798

(57) ABSTRACT

A method of chemically cleaning normally immersed suction driven filtering membranes involves backwashing a chemical cleaner through the membranes while the tank is empty in repeated pulses in which the chemical cleaner is pumped to the membranes separated by waiting periods in which chemical cleaner is not pumped to the membranes. The duration and frequency of the pulses is preferably chosen to provide an appropriate contact time of the chemical, preferably without allowing the membranes to dry between pulses and without using excessive amounts of chemical. In other aspects, such membranes preferably used for filtering water to produce potable water in a batch process are backwashed with a chemical cleaner substantially at the same time as the tank is being drained. The chemical cleaner is optionally supplied in pulses. In other aspects, chemical cleaner backwashes are started before the membranes foul significantly and are repeated at least once per week to reduce the rate of decline in the permeability of the membranes so that intensive recovery cleaning is required less frequently. When performed in situ, each cleaning event comprises (a) stopping permeation and any agitation of the membranes, (b) backwashing the membranes with a chemical cleaner in repeated pulses and (c) resuming agitation, if any, and permeation. The pulses last for between 10 seconds and 100 seconds and there is a time between pulses between 50 seconds and 6 minutes. Each cleaning event typically involves between 5 and 20 pulses.

This is a continuation-in-part of (1) U.S. application Ser. No. 09/425,234 filed Oct. 25, 1999, (2) U.S. application Ser. No. 09/425,235 filed Oct. 25, 1999, (3) U.S. application Ser. No. 09/425,236 filed Oct. 25, 1999, all of which are incorporated herein by this reference.

### FIELD OF THE INVENTION

This invention relates to cleaning normally immersed suction driven ultrafiltration and microfiltration membranes with a cleaning chemical and particularly by backwashing with a chemical cleaner.

### BACKGROUND OF THE INVENTION

Normally immersed suction driven filtering membranes are used for separating a permeate lean in solids from tank water rich in solids. Typically, filtered permeate passes through the walls of the membranes under the influence of a transmembrane pressure differential between a retentate side of the membranes and a permeate side of the membranes. Solids in the tank water are rejected by the membranes and remain on the retentate side of the membranes.

The solids may be present in the feed water in solution, in suspension or as precipitates and may further include a variety of substances, some not actually solid, including colloids, microorganisms, exopolymeric substances excreted by microorganisms, suspended solids, and poorly dissolved organic or inorganic compounds such as salts, emulsions, proteins, humic acids, and others.

Over time, the solids foul the membranes which decreases their permeability. As the permeability of membranes decreases, the yield of the process similarly decreases or a higher transmembrane pressure is required to sustain the same yield. To prevent the decreased yield of the process or the increased transmembrane pressure from becoming unacceptable, the membranes must be cleaned.

The solids may be present in the tank water in solution, in suspension or as precipitates and may further include a variety of substances, some not actually solid, including colloids, microorganisms, exopolymeric substances excreted by microorganisms, suspended solids, and poorly dissolved organic or inorganic compounds such as salts, emulsions, proteins, humic acids, and others. All of these solids can contribute to fouling but the fouling may occur in different ways. Fouling can also occur at the membrane surface or inside of the pores of the membrane. Physical cleaning methods such as aerating the membranes with scouring bubbles and backwashing with permeate counter some forms of fouling. These physical cleaning methods are not very effective, however, for removing solids deposited inside the membrane pores and are almost ineffective for removing any type of solid chemically or biologically attached to the membranes.

Accordingly, fouling continues despite regular back washing and agitation and the permeability of the membranes decreases over time. After a time, which may be as short as a couple of weeks for membranes used to treat wastewater, the permeability of the membranes reaches an unacceptable value and a different type of cleaning, which may be referred to as recovery cleaning, is performed. Such recovery cleaning is intended to substantially restore the permeability of the membranes but typically disrupts permeation for extended periods of time, reduces the remaining useful life of the membranes or is harsh on the membranes.

U.S. Pat. No. 5,403,479 and Japanese Patent Application No. 2-248,836 describe recovery cleaning methods. Permeation is stopped and the membranes are cleaned by continuously flowing a specified amount of chemical cleaner in a reverse direction through the membranes for an extended period of time while the membranes remain immersed in the wastewater and are simultaneously agitated.

French Patent No. 2,741,280 describes a method of backwashing significantly fouled membranes with a chemical cleaner continuously for at least 30 minutes. The tank water is empty during the chemical backwash. When the chemical backwash is over, the cleaner is drained from the tank and the tank is refilled.

### SUMMARY OF THE INVENTION

An object of the present invention is to provide a method of chemically cleaning normally immersed suction driven membranes. This object is met by the combination of features, steps or both found in the independent claims, the dependent claims disclosing further advantageous embodiments of the invention. The following summary may not describe all necessary features of the invention which may reside in a sub-combination of the following features or in a combination with features described in other parts of this document.

In some aspects, the invention is directed at a method of chemically cleaning normally immersed suction driven filtering membranes. A chemical cleaner is backwashed through the membranes while the tank is empty in repeated pulses in which the chemical cleaner is delivered to the membranes separated by waiting periods in which chemical cleaner is not delivered to the membranes. The duration and frequency of the pulses is chosen to provide an appropriate contact time of the chemical cleaner, preferably without allowing the membranes to dry between pulses and without using excessive amounts of chemical cleaner. When the membranes are vertically oriented hollow fiber membranes, the chemical cleaner is preferably delivered from a header at the top of the membranes only. Preferably, the chemical cleaner has a selected concentration and is provided in each cleaning event for a selected duration. The sum of the products of the concentration and the duration for all of the cleaning events performed in a week is selected to maintain an acceptable permeability of the membranes or to reduce the rate of decline in permeability of the membranes over extended periods of time.

In other aspects, the invention is directed at a process for chemically cleaning such membranes preferably used for filtering water to produce potable water in a batch process. The process involves performing chemical cleaning events from time to time. During the chemical cleaning events, the membranes are backwashed with a chemical cleaner substantially at the same time as the tank is being drained. The cleaning events are performed at least once a day. Preferably, the chemical cleaner has a selected concentration and is provided in each cleaning event for a selected duration. The sum of the products of the concentration and the duration for all of the cleaning events performed in a week is selected to maintain an acceptable permeability of the membranes or to reduce the rate of decline in permeability of the membranes over extended periods of time. The chemical cleaner may optionally be provided in repeated pulses separated by waiting periods.

In other aspects, the invention provides a method for cleaning membranes by backwashing with a chemical cleaner. Such cleaning events are started before the membranes foul significantly and are repeated at least once a week. The product of the concentration of the chemical cleaner expressed as an equivalent concentration of NaOCl and the duration of all cleaning events is between 2,000 minutes·mg/l and 30,000 minutes·mg/l per week. When performed in situ, each cleaning event comprises (a) stopping permeation and any agitation of the membranes, (b) backwashing the membranes with a chemical cleaner in repeated pulses and (c) resuming agitation, if any, and permeation. The pulses last for between 10 seconds and 100 seconds, there is a time between pulses between 50 seconds and 6 minutes. Each cleaning event typically involves between 5 and 20 pulses. The pulses may be delivered in part by the permeate pump.

### BRIEF DESCRIPTION OF THE DRAWINGS

Preferred embodiments of the invention will now be described with reference to the following figure or figures.

FIG. 1 is a schematic representation of a filtration system.

FIGS. 2, 3 and 4 are schematic representations of alternate membrane modules.

FIG. 5 is a graph of experimental results.

FIG. 6 is another graph of experimental results.

### DETAILED DESCRIPTION OF THE INVENTION

### General Description of a Filtration or Permeation Process

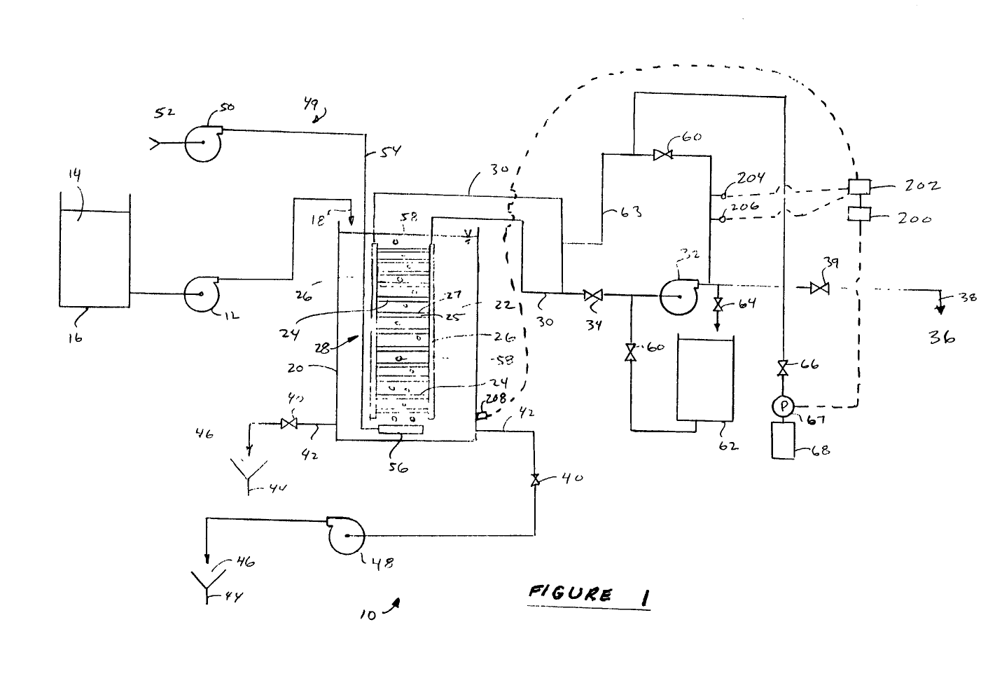

FIG. 1 shows a reactor 10 for treating a liquid feed 14 having solids to produce a filtered permeate substantially free of solids. A feed pump 12 pumps feed 14 to be treated from a water supply 16 through an inlet 18 to a tank 20 where it becomes tank water 22. In an industrial or municipal reactor 10, the tank 20 is typically between 1 m and 10 m deep. During permeation, the tank water 22 is maintained at a level which covers one or more membranes 24. Each membrane 24 has an inner permeate side 25 which does not contact tank water 22 and an outer retentate side 27 which does contact the tank water 22. If the process is being used for waste water treatment, biological activity in the tank water 22 substantially alters the character and concentration of pollutants in the tank water 22 and the tank water 22 would typically be referred to as mixed liquor. In this description, however, tank water 22 refers to both tank water 22 intended to be filtered for drinking and mixed liquor.

Membranes 24 made of hollow fibers are preferred although the membranes 24 may be of various other types such as tubular, ceramic, or flat sheet. Typically, headers 26 connect a plurality of hollow fiber or tubular membranes 24 together, potting resin in the headers 26 sealing the ends of the membranes and connecting the permeate sides 25 of the membranes 24 to appropriate piping. Similarly, flat sheet membranes are typically attached to headers or casings that create an enclosed surface on one side of a membrane or membranes and allow appropriate piping to be connected to the interior of the enclosed surface. A header or casing holding one or more membranes may be referred to as a module. A plurality of modules may also be joined together and may be referred to as a cassette. In this description, however, the words “membrane” and “membranes” both refer to one or more membranes whether or not they are connected in one or more modules or cassettes.

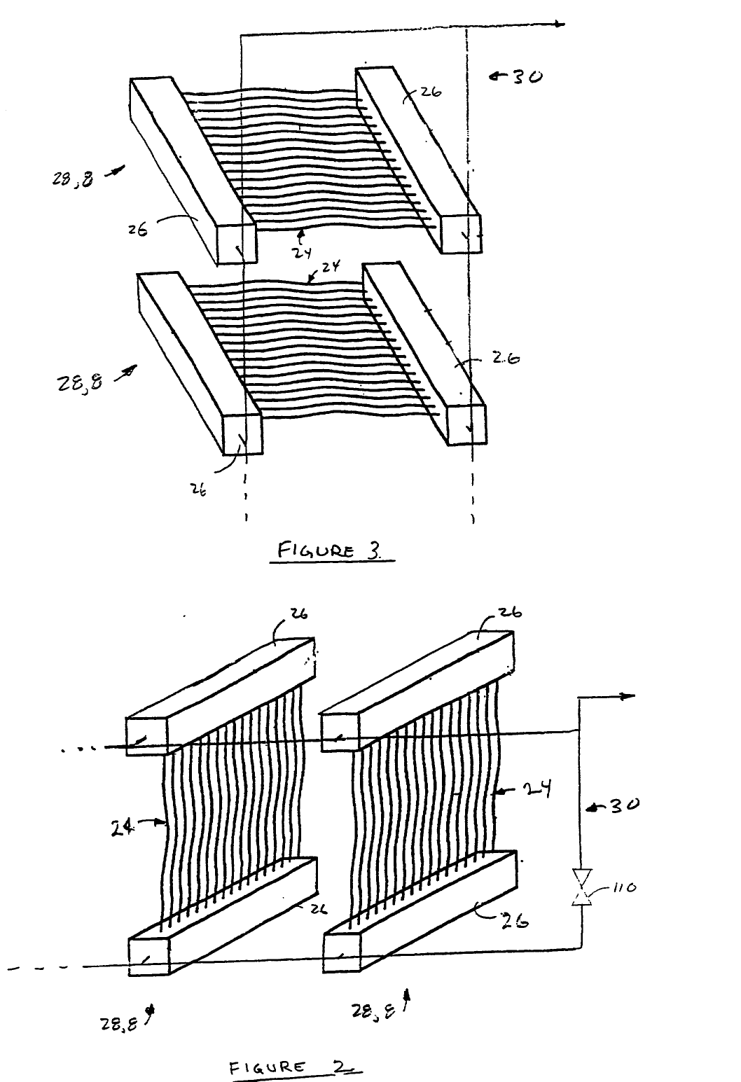

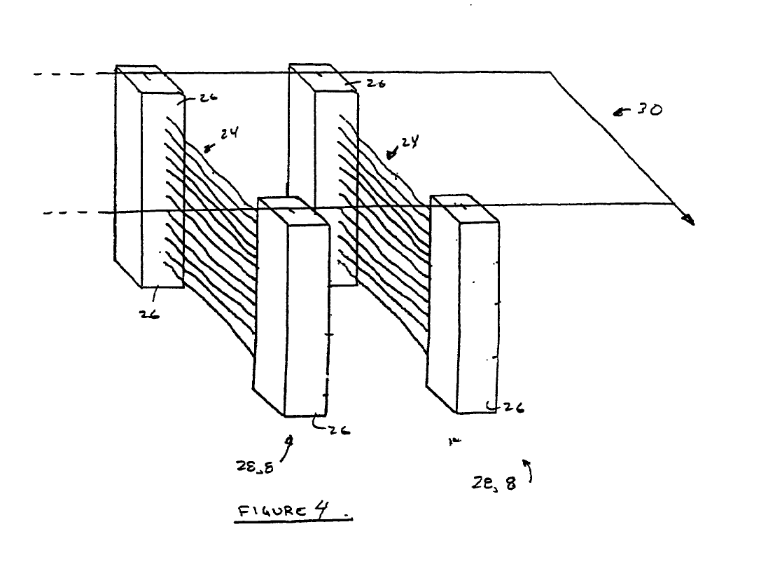

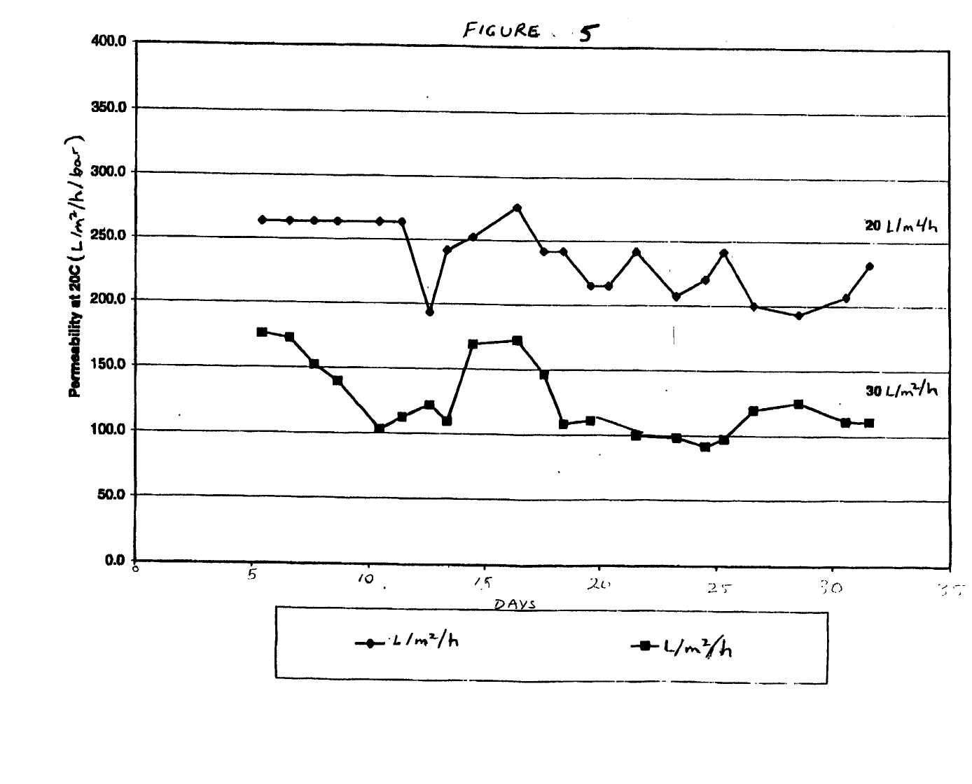

Referring to FIG. 2, a membrane module 28 may be made of multiple assemblies of membranes 24 and headers 26 called skeins 8. FIGS. 3 and 4 show skeins 8 in alternate orientations. Although only a few membranes 24 are illustrated, the skeins 8 are typically between 2 cm and 10 cm wide potted to a packing density between 10% and 40% with hollow fiber membranes 24 having an outside diameter between 0.4 mm and 4.0 mm. The hollow fiber membranes 24 may be between 400 mm and 1,800 mm long and mounted with between 0.1% and 5% slack. The membranes 24 have an average pore size in the microfiltration or ultrafiltration range, preferably between 0.003 microns and 10 microns and more preferably between 0.02 microns and 1 micron. Suitable membranes include those sold under the ZEEWEED trade mark and produced by Zenon Environmental Inc. The total size and number of membranes 24 required varies for different applications depending on factors such as the amount of filtered permeate 36 required and the condition of the feed 14.

Referring again to FIG. 1, for hollow fiber membranes 24, the retentate side 27 of the membranes 24 is preferably the outside of the membranes and the permeate side 25 of the membranes 24 is preferably their lumens. To collect permeate the conduit or conduits of headers 26 are connected to a permeate collector 30 and a permeate pump 32 through a permeate valve 34. When permeate pump 32 is turned on and permeate valve 34 and an outlet valve 39 opened, a negative pressure is created on the permeate side 25 of the membranes 24 relative to the tank water 22 surrounding the membranes 24. The resulting transmembrane pressure, typically between 1 kPa and 100 kPa and preferably less than 67 kPa for ZEEWEED hollow fiber membranes 24, draws tank water 22 (then referred to as permeate 36) through membranes 24 while the membranes 24 reject solids which remain in the tank water 22. Thus, filtered permeate 36 is produced for use at a permeate outlet 38 through the outlet valve 39. Periodically, a storage tank valve 64 is opened to admit permeate 36 to a storage tank 62. The transmembrane pressure could alternately be created by pressurizing the tank water 22.

Tank water 22 which does not flow out of the tank 20 through the permeate outlet 38 flows out of the tank 20 through a drain valve 40 in a retentate outlet 42 to a drain 44 as retentate 46 with the assistance of a retentate pump 48 if necessary. Optionally, tank water 22 which does not flow out of the tank 20 through the permeate outlet 38 may leave the tank 20 by overflowing the tank 20 in addition to or in place of flowing out of the retentate outlet 42. In drinking water applications, the retentate 46 may be withdrawn from the tank 20 either continuously or periodically. In wastewater applications, the reactor 10 is usually operated continuously. In periodic operation, filtering typically occurs in a batch mode and the tank is emptied frequently. In continuous operation, although there may be short periodic interruptions, feed 14 flows into the tank 20 and permeate 36 is withdrawn from the tank over extended periods of time and retentate 46 is withdrawn as needed to preserve the required level of tank water 22 in the tank 20. In some drinking water applications, the process operates continuously but for periodic, ie. once a day, tank drainings for maintenance procedures.

During permeation, solids accumulate on the surface of the membranes 24 and in their pores, fouling the membranes 24. Physical techniques may prevent some of this fouling. For example, the membranes 24 may be aerated. For this, an aeration system 49 has an air supply pump 50 which blows air, nitrogen or another appropriate gas from an air intake 52 through air distribution pipes 54 to one or more aerators 56 located generally below the membrane modules 28 which disperses air bubbles 58 into the tank water 22. The air bubbles 58 agitate the membranes 24 and create an air-lift effect causing tank water 22 to flow upwards past the membranes 24, all of which inhibits fouling of the membranes 24.

In addition to aeration, the membranes 24 may be backwashed with permeate periodically. For this, permeate valve 34, outlet valve 39 and storage tank valve 64 are closed while backwash valves 60 are opened. Permeate pump 32 is turned on to push filtered permeate 36 from storage tank 62 through a backwash pipe 63 to the headers 26 and through the walls of the membranes 24 in a reverse direction thus pushing away some of the solids attached to the membranes 24. At the end of the backwash, backwash valves 60 are closed. Permeate valve 34 and outlet valve are 39 re-opened if permeation will resume. Such backwashing may occur approximately every 15 minutes to 90 minutes for a period of 15 seconds to one minute and, although permeation is temporarily disrupted, a continuous process is still considered continuous. Permeate 36 may be stored in a permeate tank (not shown) to even out minor disruptions in the flow of permeate 36.

Embodiments of the present invention, to be described below, are directed at reducing the rate of loss of permeability of the membranes 24 so that the time between intensive recovery cleanings can be lengthened. This strategy is referred to generally as maintenance cleaning. In addition to regular periodic backwashing, cleaning events are performed generally periodically at least once a week. The cleaning events are started before there is significant fouling of fresh membranes 24, preferably while permeability is still above 70% of the permeability of the membranes 24 when fresh, and more preferably within a week of when permeation is started with fresh membranes, fresh meaning new membranes 24 or membranes 24 that have just been through intensive recovery cleaning.

### Chemical Cleaning with Tank Drained or Draining

Chemical cleaning events are performed with the tank 20 either empty or emptying, typically through the retentate outlet 42. To clean the membranes 24 with chemical cleaner, permeation is temporarily stopped, permeate valve 34, outlet valve 39 and backwash valves 60 are all closed and permeate pump 32 is turned off. Chemical cleaner is delivered to the membranes 24 and flows through the walls of the membranes 24. The chemical cleaner used may be any chemical appropriate for the application and not overly harmful to the membranes 24. Typical chemicals include oxidants such as sodium hypochlorite, acids such as citric acid and bases such as sodium hydroxide. The chemical cleaner may be used in a non-liquid form such as by flowing chemical in a gaseous state to the headers 26 or introducing it as a solid into the backwash line 63. Liquid chemical cleaners are preferred, however, because they are easier to handle and inject in the proper amounts.

To flow chemical cleaner through the walls of the membranes 24, chemical valve 66 is opened and chemical pump 67 turned on to flow chemical cleaner from chemical tank 68 to backwash line 63, headers 26 and into or through the walls of the membranes 24. After the chemical cleaning is completed, chemical pump 67 is turned off and chemical valve 66 is closed. Preferably, the backwash valves 60 are opened and permeate pump 32 operated to provide a rinsing backwash to remove chemical cleaner from the backwash line 63 and permeate collectors 30.

Alternatively, backwash valves 60 are opened and permeate pump 32 operated to push filtered permeate 36 from permeate tank 62 through backwash line 63 to the headers 26. Chemical valve 66 is opened and chemical pump 67 turned on mixing chemical cleaner from chemical tank 68 with permeate 36 flowing through backwash line 63. Chemical cleaners could also be introduced directly to the headers 26 or the permeate collector 30 which may reduce the total volume used or allow alternate delivery mechanisms. The membranes 24 can be backwashed with chemical free permeate at the end of a cleaning event to wash chemical cleaner out of the membranes 24 and the tank 20.

In one embodiment, cleaning events are performed with the tank 20 empty. The cleaning events may begin while the tank 20 is being drained but, unlike the embodiment described above, the cleaning events continue for a significant period of time after the tank 20 is drained to below the level of the membranes 24. During the cleaning events, the membranes 24 are backwashed with a chemical cleaner in repeated pulses in which the chemical cleaner is delivered to the membranes. The pulses are separated by a time in between pulses in which chemical cleaner is not delivered to the membranes.

Preferably, the time between pulses approximates the time required for a dose of chemical to either flow out of the pores of the membranes 24 or to be substantially consumed through reactions with solids such that the membranes 24 are no longer effectively wetted with chemical cleaner. This time may vary with the packing density and configuration of the membrane module 28, the diameter of the membranes 24 and other factors. Providing too short a time between pulses wastes chemical cleaner by forcing it into the tank 20 prematurely while providing too long a time between pulses wastes process time because the chemical cleaner is not sufficiently efficacious for the entire time. Conversely, the duration of the pulse preferably approximates the time required to effectively re-wet the membranes 24 to an initial wetness. In this way, chemical cleaner contacts the membranes 24 for substantially the duration of the cleaning event.

The duration of the pulses is typically between 10 seconds and 120 seconds, more typically between 30 and 60 seconds, and the time in between pulses is typically between 30 seconds and five minutes, more typically about three minutes. Preferably, the first pulse is about 1 to 5 minutes, typically 2 minutes, in duration regardless of the duration of subsequent pulses to fully displace permeate from the permeate sides 25 of the membranes 24 with chemical cleaner such that the next pulse will immediately produce a flow of chemical cleaner through the membranes. Optionally, this first pulse can be performed before the tank is drained or while the tank is draining.

The pressure of the pulses is preferably high enough to substantially reduce the relative size of differences in local pressure on the permeate side 25 of the parts of the membranes 24 located at different elevations in the tank 20. The pulses preferably have a pressure which exceeds the pressure of a column of water having a height equal to the maximum difference in elevation between two portions of the membranes which typically ranges between 10 and 55 kPa. This produces less variation in the rate of flow of chemical cleaner through different parts of the membranes 24 as compared to when a lower pressure is used and less chemical cleaner is required to achieve a minimum level of cleaning throughout the membranes 24. When vertically oriented hollow fiber membranes 24 are used, the chemical cleaner is preferably delivered to the membranes 24 only through an upper header 26. The head loss in the flow of chemical cleaner through the membranes 24 further assists in counteracting the differences in local pressure inside the lumens of different parts of the membranes 24 caused by differences in elevation in the tank 20. Where such vertically oriented membranes 24 are serviced by upper and lower headers 26 as shown in FIG. 3, a lower header cut-off valve 110 is closed so that chemical cleaner flows only into the upper header 26.

The pulsed chemical cleaner delivery is particularly beneficial for modern submerged outside-in hollow fiber membranes 24 which are between 1 meter to 3 meters in length, resulting in significant pressure drop in the lumens of the membranes 24, but having unfouled permeability of a few hundred liters per square meter per hour per bar of transmembrane pressure (L/m²/h/bar) or more. In particular, with chemical cleaner flowing into the upper header 26 only of a membrane module 28 with vertical hollow fiber membranes 24, the head loss in the lumens of the membranes 24 assists in reducing the flow of chemical cleaner through the lower portions of the membranes 24 which, as explained above, tend to receive too much chemical cleaner. With such membranes 24 and chemical cleaner flowing into upper headers 26 only, a preferred flux of chemical cleaner between 30 and 55 L/m²/h produces an effective backwash with a pulse pressure near the pressure of a column of water having a height equal to the maximum difference in elevation between two portions of the membranes.

For example, a ZW 500 membrane module manufactured by ZENON Environmental Inc. has vertical hollow fiber membranes approximately 1650 mm in length. In a test with partially fouled fibers having a permeability of 250 L/m²/h/bar and backwashing from the top header only, backwashing at 7 kPa resulted in a flux of chemical cleaner through the membranes varying from about 17 L/m²/h at the top of the membranes to about 39 L/m²/h at the bottom of the membranes. Backwashing at 22 kPa resulted in a flux of about 54 L/m²/h at the top, about 50 L/m²/h near the middle and about 61 L/m²/h near the bottom of the fibers. Thus backwashing at 22 kPa substantially reduced the variation in flux across different parts of the membranes. Continuous backwashing at such a pressure, however, would use excessive amounts of cleaning chemical.

The pressure of the pulses may be controlled by altering the speed of the chemical pump 67 (or the permeate pump 32 and the chemical pump 6 when both are used) with a speed controller 200. Based on the expected permeability of the membranes 24 when fouled, the flux through the membranes at a given pressure can be calculated. From this flux the speed of the chemical pump 67 can also be calculated. The speed controller 200 can thus be set to run the chemical pump 67 at this speed during the parts of the chemical backwash cycle during which the chemical pump 67 is on.

Preferably, the speed controller 200 is controlled by a programmable logic controller 202. The programmable logic controller (PLC) 202 is programmed to turn the chemical pump 67 on and off in repeated cycles for the duration of the cleaning event. With the on and off times chosen to keep the membranes 24 effectively wetted with chemical cleaner, T entered into the PLC 202 which is programmed to start a timer with the first pulse of chemical cleaner and continue to provide chemical cleaner pulses until T is reached on the timer. More typically, however, T is made to be an even multiple of a selected time between pulses and the PLC is programmed to provide a selected number of pulses.

The PLC 202 starts each on portion of a cleaning event with the chemical pump 67 at the speed calculated above. Optionally, a pressure gauge 204 senses the pressure in the backwash line 63 and converts this information to an analog current or potential signal, preferably a 4-20 mili amp current signal, proportional to the pressure. The PLC 202 converts this signal to a pressure reading and compares the pressure reading to the desired pressure which is entered into the PLC 202 by an operator. Based on the comparison, the PLC 202 in turn sends an analog current or potential signal, preferably a 4-20 mili-amp current signal, to the speed controller 200. The speed controller 200 changes the frequency of the electric current to the chemical pump 67 in proportion to the signal presented by the PLC 202, which changes the speed of the chemical pump 67, and hence, the chemical cleaner flux and pressure. If the pressure is below the desired value, the speed of the chemical pump 67 is increased by the PLC 202 and conversely decreased if the pressure is too high. In this way, increases in the permeability of the membranes 24 as they are cleaned are compensated for by increasing the speed of the chemical pump 67.

Further optionally, a flow sensor 206 in the backwash line 63 measures the increase in chemical flux caused by such increases in speed of the chemical pump 67 and converts this information to an analog current or potential signal, preferably a 4-20 mili-amp current signal proportional to the flux. The PLC 202 converts this signal to a flux reading. As the chemical flux increases, the time taken to re-wet the membranes 24 decreases. Accordingly, the PLC 202 is programmed to shorten the length of time during which the chemical pump 67 is turned on as the flux of chemical cleaner increases. A level sensor 208 associated with the tank 20 can also be used in conjunction with one or more of the sensors described above and information about the permeability of the membranes 24 to permit the PLC 202 to determine an appropriate speed of the relevant pump to achieve a desired minimum flow of cleaning chemical through membranes 24 at the top of a membrane module 28.

Alternatively, in a large municipal system in which large groups of membrane modules 28 (sometimes called cassettes) are provided each with separately operable valves, the pulsing can be achieved by opening and closing the relevant valves to provide a pulse of cleaning chemical to the various cassettes is sequence. For example, a regimen of 10 second pulses with 50 second waiting periods can be achieved by breaking up the total number of membrane modules 28 into six equal groups, operating the permeate pump 32 or chemical pump 67 to deliver a constant flow of cleaning chemical and opening the relevant valves to each of the six groups of membrane modules 28 in sequence for 10 seconds out of every 60 seconds. This technique reduces wear on the relevant pump cause by its frequent stopping and starting and reduces the extent of a period at the beginning an end of each pulse where the flow of chemical cleaner is increasing or decreasing.

In another embodiment, the chemical cleaning is performed while the tank is being drained. After the drain valves 40 are opened, the permeate pump 32 or chemical pump 67, whichever governs, is controlled to feed the cleaning chemical into the membranes 24, preferably with sufficient pressure to produce a flux of chemical through the membranes 24 between 8.5 L/m²/h and 51 L/m²/h.

In most industrial or municipal installations it typically takes between two and ten minutes and more frequently between two and five minutes to drain the tank 20 completely. The time taken to drain the tank 20 can be controlled by operating the retentate valves 40 as required to provide a selected drain time. In combination with a maintenance cleaning regime (to be described below), practical drain times are sufficient to chemically clean the membranes. It is not necessary that the chemical backwash be entirely simultaneous with the tank draining, but it should be substantially so. Once the tank 20 is empty and chemical backwashing is complete, drain valves 40 are closed and a new cycle begins.

By having the chemical backwash coincide with draining the tank 20, a chemical cleaning event that leaves little or no residual chemical cleaner in the tank 20 is performed with minimum loss in permeate production time. In addition, dilution of the cleaning chemical into the tank water occurs only from the portion of membranes 24 or parts of membranes 24 (where the membranes 24 are vertical) covered in tank water, which proportion continually decreases during the backwash. Further, the upper membranes 24 or parts of membranes 24 receive as much chemical as the lower membranes 24 or parts of membranes 24 at least near the beginning of the backwash when the tank water 22 provides a greater head against the lower membranes 24. Thus, the inventors believe that the chemical backwash while draining is at least comparable, if not superior, in contact time generated for a given volume of chemical cleaner to backwashing into either a full or empty tank 20.

In a third embodiment, the two embodiments above are combined to create a pulsed backwash that is performed substantially while the tank 20 is being drained. In this embodiment, the distribution of cleaning chemical is further improved. To accommodate the limited time of the cleaning event, however, the duration of the pulses is preferably between 5 seconds and 30 seconds and the waiting periods preferably last between 30 seconds and 90 seconds.

For all of the embodiments mentioned above, the effectiveness of a chemical cleaning event or backwash may be approximated by multiplying the concentration “C” of the chemical cleaner and the time, “T”, that the chemical cleaner effectively wets the membranes 24 to create a third parameter “CT”. The preferred CT for each event is selected by an operator according to his or her preferred chemical cleaning regimen, for example a maintenance cleaning regimen as will be described below. Once the CT is selected, a concentration of chemical cleaner is selected. In possible alternative embodiments, the chemical cleaner may be diluted before it reaches the membranes 24. For example, with appropriate modifications to the procedure and apparatus above, backwash valves 60 can also be opened and permeate pump 32 used to flow permeate 36 through backwash line 63 where it mixes with chemical cleaner from the backwash line 63. The concentration of the chemical cleaner is therefore measured as the chemical cleaner meets the permeate side 25 of the membranes 24. A typical chemical cleaner is NaOCl at a concentration between 10 and 200 mg/L. Once C is known, T can be calculated to achieve a desired CT. Since the cleaning events may be repeated with varying frequency for different applications or concentrations of solids in the feed 14, a parameter called the weekly CT is used as a basis for some calculations. The weekly CT is the sum of the CT parameters for the cleaning events performed during a week.

The embodiments described above are preferably combined with a maintenance cleaning regimen in which the cleaning events are started before the membranes 24 foul significantly. The desired weekly CT is preferably chosen to maintain an acceptable or stable or substantially constant permeability of the membranes 24 or to reduce the rate of decline in permeability of membranes 24 over extended periods of time, preferably between 1 month and 6 months, so as to reduce the frequency of intensive recovery cleanings rather than to provide recovery cleaning itself. An acceptable permeability may be one half of the permeability of the membranes when they were new and a recovery cleaning may be performed when the permeability of the membranes decreases below this point. In some drinking water applications, however, intensive recovery cleanings can be postponed almost indefinitely. There may be a slight instantaneous increase in permeability of the membranes 24 after a cleaning event, but this permeability gain is typically lost before the next cleaning event and is not significant enough to be considered recovery cleaning.

For drinking water applications, the weekly CT is preferably between 1,000 min*mg/L to 20,000 min*mg/L when NaOCl is the chemical cleaner and more preferably between 1,000 min*mg/L and 10,000 min*mg/L of NaOCl. When other chemical cleaners are used, the concentration of the chemical cleaner is expressed as an equivalent concentration of NaOCl that has similar cleaning efficacy. For example, for citric acid preferred values are approximately 20 times those given for NaOCl and for hydrochloric acid preferred values are approximately 4 times the values given for NaOCl. For applications in which the membranes are used to produce a filtered effluent from a wastewater treatment process, the product of the concentration of the chemical cleaner expressed as an equivalent concentration of NaOCl in cleaning efficacy and the duration of the cleaning events in a week is between 10,000 min*mg/L and 30,000 min*mg/L. Dividing the weekly CT by the number of cleaning events in a week gives the CT of each cleaning event.

For the pulsed chemical backwash into an empty tank, the duration of cleaning events is not limited by the time required to drain the tank. Such cleaning events are repeated at least once a week, preferably between 1 and 4 times a week. Each cleaning event involves between 5 and 30 pulses, preferably between 6 and 10 pulses times, with a total duration between 10 and 100 minutes, preferably about 30 minutes.

Where the chemical backwash is performed substantially while draining the tank, the cleaning events are performed more frequently, preferably at least once a day. Where such cleaning events are used in conjunction with a batch filtration process in which the tank is emptied periodically at least once a day, the cleaning events may be performed as often as every time the tank is so drained.

### Chemical Cleaning In Situ

In another embodiment, each cleaning event involves flowing chemical cleaner through the walls of the membranes 24 while permeation is temporarily stopped in a direction opposite to the direction in which permeate 36 flows through the membranes 24 during permeation. The chemical cleaner used may be any chemical appropriate for the application and not overly harmful to the membranes 24. Typical chemicals include oxidants such as sodium hypochlorite, acids such as citric acid and bases such as sodium hydroxide. The chemical cleaner may be used in a non-liquid form such as by flowing chemical in a gaseous state to the headers 26 or introducing it as a solid into the backwash line 63. Liquid chemical cleaners are preferred, however, because they are easier to handle and inject in the proper amounts.

To flow chemical cleaner through the walls of the membranes 24 while permeation is temporarily stopped, permeate valve 34, outlet valve 39 and backwash valves 60 are all closed and permeate pump 32 turned off. Chemical valve 66 is opened and chemical pump 67 turned on pushing chemical cleaner from chemical tank 68 into backwash line 63 to the headers 26 and through the walls of the membranes 24. Alternately, permeate valve 34 and outlet valve 39 may be closed and backwash valves 60 opened. Permeate pump 32 then pushes filtered permeate 36 from pressure tank 62 through backwash line 63 to the headers 26 and through the walls of the membranes 24. Chemical valve 66 is opened and chemical pump 67 turned on mixing chemical cleaner from chemical tank 68 with permeate 36 flowing through backwash line 63. Further alternately, permeate pump 32 is stopped and chemical valve 66, permeate valve 34 and outlet valve 39 are closed while backwash valves 60 are opened. A cross flow valve 69 is also opened connecting the chemical tank 68 to the pressure tank 62. Chemical pump 67 delivers chemical cleaner to pressure tank 62. Permeate pump 32 is then operated to deliver the chemical cleaner to the membranes 24. Chemical cleaners could also be introduced directly to the headers 26 or the permeate collector 30 which may reduce the total volume used or allow alternate delivery mechanisms.

With some of the methods of flowing chemical cleaner through the walls of the membranes 24 described above, the chemical cleaner may be diluted before reaching the membranes 24. Accordingly, in the subject method the concentration of the chemical cleaner is measured as the chemical cleaner meets the permeate side 25 of the membranes 24 unless stated otherwise. This concentration will be referred to as “C”.

As the chemical cleaner flows towards and through the walls of the membranes 24, it displaces tank water 22 in the lumens of the membranes 24 and in an area adjacent to the membranes. The chemical cleaner surrounds the membranes 24 but is not encouraged to mix with the tank water 22. In particular, sources of agitation such as the aeration system 49 are preferably turned off if they have a significant effect on the tank water 22 adjacent the membranes 24. Without such mixing, some chemical cleaner leaves the area adjacent the membranes 24 but only slowly. In the area adjacent the membranes 24, the chemical cleaner reacts with the solids on or in the membranes 24 killing some microorganisms attached to the membranes 24 and dissolving some of the solids. Outside of this area, the concentration of chemical cleaner in the tank water 22 drops.

The effectiveness of the chemical cleaner is dependant on the concentration of the chemical cleaner and the time that the chemical cleaner remains effective in the area adjacent the membranes 24. For process calculations, the concentration of the chemical cleaner in the area adjacent the membranes 24 is assumed to be the same as the initial concentration of the chemical cleaners 24, C. The time during which the chemical cleaner remains effective in the area adjacent the membranes 24 will be called “T”. Permeation and agitation are stopped, preferably for about five minutes, before the chemical cleaner starts to flow through the membranes 24. After the flow of chemical cleaner stops, agitation is resumed for about ten minutes to dilute the chemical cleaner in the area adjacent the membranes 24 before permeation resumes.

In the above case, T is assumed for calculations to be the time between when chemical cleaner starts to flow through the membranes 24 and when agitation is resumed, provided that agitation resumes within about five minutes after the flow of chemical cleaner stops. If necessary, the permeate side 25 of the membranes 24 and piping containing chemical may also be flushed with a backpulse of filtered permeate 36 before resuming permeation, in which case the start of this backpulse would be the end of the cleaning event if it had not already ended. Alternatively, permeation may resumed before agitation. This method is advantageous in that chemical cleaner in the area adjacent the membranes 24 is not dispersed into the tank 20, but the permeate 36 collected before resuming agitation is preferably wasted or recycled to the tank water 22 to reduce the amount of chemical cleaner entering the permeate tank 37. In this case, T is assumed for calculations to be the time between when chemical cleaner starts to flow through the membranes 24 and when the first of agitation or permeation are resumed, provided that agitation or permeation resumes within about five minutes after the flow of chemical cleaner stops.

The effectiveness of a cleaning event is approximated by multiplying the C and T parameters to create a third parameter “CT”. Since the cleaning events may be repeated with varying frequency for different applications or concentrations of solids in the feed 14, a parameter called the weekly CT is used as a basis for some calculations. The weekly CT is the sum of the CT parameters for the cleaning events performed during a week. If cleaning events are performed less frequently than once a week, a monthly CT parameter can be used instead with appropriate modifications to the calculations which depend on the weekly CT parameter.

The desired weekly CT is preferably chosen to maintain an acceptable or stable or substantially constant permeability of the membranes 24 or to reduce the rate of decline in permeability of membranes 24 over extended periods of time, preferably between 15 days and three months, so as to reduce the frequency of intensive recovery cleanings rather than to provide recovery cleaning itself. An acceptable permeability may be one half of the permeability of the membranes when they were new and a recovery cleaning may be performed when the permeability of the membranes decreases below this point. In some drinking water applications, however, intensive recovery cleanings can be postponed almost indefinitely. There may be a slight instantaneous increase in permeability of the membranes 24 after a cleaning event, but this permeability gain is typically lost before the next cleaning event and is not significant enough to be considered recovery cleaning.

The weekly CT is preferably in the range of 2,000 min·mg/l to 30,000 min·mg/l when NaOCl is the chemical cleaner. For drinking water applications, the preferred weekly CT is between 5,000 min·mg/l and 10,000 min·mg/l of NaOCl. For waste water applications, the preferred weekly CT is between 10,000 min·mg/l and 30,000 min·mg/l of NaOCl. When other chemical cleaners are used, the concentration of the chemical cleaner should be expressed as an equivalent concentration of NaOCl that has similar cleaning efficacy. For example, for citric acid, preferred values are approximately 20 times those given for NaOCl and for hydrochloric acid, preferred values are approximately 4 times the values given for NaOCl. The precise weekly CT to use in a given application is preferably chosen to achieve a gradual decline in permeability over an extended period of time.

For a given weekly CT, the weekly duration of cleaning events is calculated by dividing the weekly CT by the concentration, C, of chemical cleaner. For NaOCl, a C between 20 mg/l and 200 mg/l is typical. Once the total weekly duration of cleaning events is known, the frequency of cleaning events is next determined. Frequent cleaning events may be more effective and provide less variation in permeability of the membranes 24 over time but require more frequent disruptions to permeation. Preferably, cleaning events are also not so frequent that, given the residence time of the tank 20 or permeate tank 37, residual chemical cleaner from a prior cleaning event is still present at the start of the next cleaning event in significant amounts. Cleaning events are performed preferably between 1 and 7 times per week and more preferably between 2 and 4 times per week. The duration, T, of each cleaning event is then determined by dividing the weekly duration of cleaning events by the number of times per week that cleaning events are performed. T typically ranges from 10 to 100 minutes and more typically from 30 minutes to 60 minutes, 30 minutes for drinking water applications and 60 minutes for wastewater applications.

Once the duration of each cleaning event is known, the flow rate of chemical cleaner during each cleaning event is determined. The flow rate is chosen to maintain an area in and adjacent to the membranes 24 in which the chemical cleaner is substantially undiluted and effective.

Chemical cleaner may be applied at a steady rate over a significant portion of the duration, T, of the cleaning event. The permeate pump 32 or chemical pump 67, whichever governs, is controlled to feed the cleaning chemical into the membranes 24 at a low pressure.

Preferably, however, the chemical cleaner is supplied to the membranes 24 in pulses rather than continuously. In the time between pulses, the chemical cleaner moves from the area in or adjacent the membranes 24 into the tank water 22 generally and reacts with solids, thus losing its efficacy. The concentration and efficacy of chemical cleaner in the area in or adjacent the membranes 24 over the duration T of the cleaning event is still sufficient, however, to provide cleaning in this area.

With a pulsed delivery of chemical cleaner, a higher pressure is used to deliver the same volume of chemical cleaner compared to when the chemical cleaner is delivered under constant pressure over the same T. This assists in reducing the relative size of variations in head losses in the membranes 24 or the piping to the membranes 24. Further, membranes rarely foul evenly and the pulsed delivery of chemical cleaner assists in providing an even distribution of chemical cleaner across the surface of the membranes 24. With less variable flow of chemical cleaner from one part of the membranes 24 to another, less chemical cleaner is required to achieve a minimum level of cleaning throughout the membranes 24. The pulsed chemical cleaner delivery is particularly beneficial for modern submerged outside-in hollow fiber membranes 24 which may be between 1 meter to 3 meters in length, resulting in significant pressure drop in the membranes 24, but having unfouled permeability of a few hundred liters per square meter per hour per bar of transmembrane pressure (L/m2/h/bar) or more. With such membranes, a pulse pressure between 5 and 55 kPa above the pressure on the outside of the membranes 24 is preferred.

Preferably, the pulses last for between 10 seconds and 100 seconds, preferably between 20 seconds and 60 seconds and more preferably 30 seconds for wastewater applications and 60 seconds for drinking water applications. In either application, however, the first pulse is preferably longer, about two minutes, to purge the membranes 24 of tank water 22. Preferably, the permeate pump 32 or chemical pump 67, whichever is controlling, supplies the chemical cleaner to the membranes 24 with sufficient pressure to produce a flux of chemical through the membranes 24 between 8.5 L/m2/h and 51 L/m2/h. Where the cleaning is in situ, a flux near 8.5 L/m2/h is preferred for drinking water applications and a flux near 20 L/m2/h is preferred for wastewater applications. Where the cleaning is done in an empty tank, a higher flux around 40 L/m2/h is preferred. After each pulse, the flow of chemical cleaner is stopped for a waiting period preferably between 50 seconds and 6 minutes and more preferably about 3 minutes for drinking water applications and about 5 minutes for wastewater applications. The pulse and waiting period may be repeated and preferably are repeated between 5 and 30 times.

The relationship between the length of the pulse and the waiting period between pulses is preferably such that the chemical cleaner remains substantially effective during the waiting period despite decreasing in efficacy from an initial efficacy and is restored to the initial efficacy by the subsequent pulse. Providing too short a time between pulses increases the amount of chemical required by forcing it into the tank prematurely while providing too long a time between pulses wastes process time because the chemical cleaner is not substantially efficacious for the entire time.

The pulses are controlled by altering the speed of the chemical pump 67 with a speed controller 100 to get the desired flux during the parts of the chemical backwash cycle during which the chemical pump 67 is on. Preferably, the speed controller 100 is in turn controlled by a programmable logic controller 102. The programmable logic controller (PLC) 102 is programmed to turn the chemical pump 67 on and off as required for the cleaning event. A flow sensor 106 in the backwash line 63 measures the chemical flux and converts this information to an analog current (typically 4-20 milli-amp) or potential signal proportional to the flux. The PLC 102 converts this signal to a flux reading, compares the flux reading to a desired flux programmed in its memory and sends a 4-20 mA or 4-20 mV signal to the speed controller 100. The speed controller 100 changes the frequency of the electric current to the chemical pump 67 in proportion to the signal presented by the PLC 102, which changes the speed of the chemical pump 67, and hence, the cleaning chemical flux. If the flux is below the desired value, the speed of the chemical pump 67 is increased by the PLC 102 and conversely decreased if the flux is to high.

The amount of chemical cleaner used per square meter of surface area of the membranes 24 per week is between 50 and 1000 mg of NaOCl, but is preferably between 220 and 550 mg of NaOCl. When other chemical cleaners are used, an amount of chemical cleaner is used which is equivalent to the amount of NaOCl specified above in cleaning efficacy. Such a dosage, spread out over the cleaning events in a week, is low enough that it does not disrupt the population of microorganisms to the point where a spike of pollutants makes the effluent quality unsatisfactory.

For drinking water applications where the cleaning is done in situ, the total volume of chemical cleaner introduced into the tank water 22 in each cleaning event, called the cleaning event dosage, is monitored. The cleaning event dosage preferably does not exceed the most limiting regulatory or design limit on the concentration of chemical cleaner in the permeate at any point of use. For example, with chlorine based chemical cleaners, trihalomethane formation is likely to be the controlling factor and can be predicted using trihalomethane formation tables. In appropriate circumstances, the volume of the permeate tank 37 may be considered in calculating the cleaning event dosage. Similarly, any prechlorination or chemical cleaner remaining in the tank 20 from a preceding cleaning event should be accounted for in determining whether a cleaning event dosage is acceptable. On the other hand, some of the chemical cleaner will react with organics in the tank water 22 resulting in lower residual chemical cleaner.

In many cases, the cleaning event dosage will be well below the maximum cleaning event dosage that could be used. However, if this does not occur in a particular application, the cleaning regime is altered to give acceptable cleaning event dosages. In some cases, altering the frequency of cleaning events may produce acceptable cleaning event dosages without reducing the weekly CT, but in other cases a higher fouling index and lower weekly CT may be required. If these measures still do not produce acceptable levels of residual chemical cleaner, then for drinking water applications some or all of the tank water 22 is drained after the cleaning events and replaced with feed 14. Alternatively, the continuous process can be replaced with a batch process and the cleaning events performed when the tank is empty.

After a cleaning event as described above, backwash valves 60 are closed, permeate valve 34 is re-opened, pressure tank 64 opened if and as necessary to refill pressure tank 62, and permeation continues. New chemical cleaner is added to the chemical tank 68 as needed.

### EXAMPLE 1

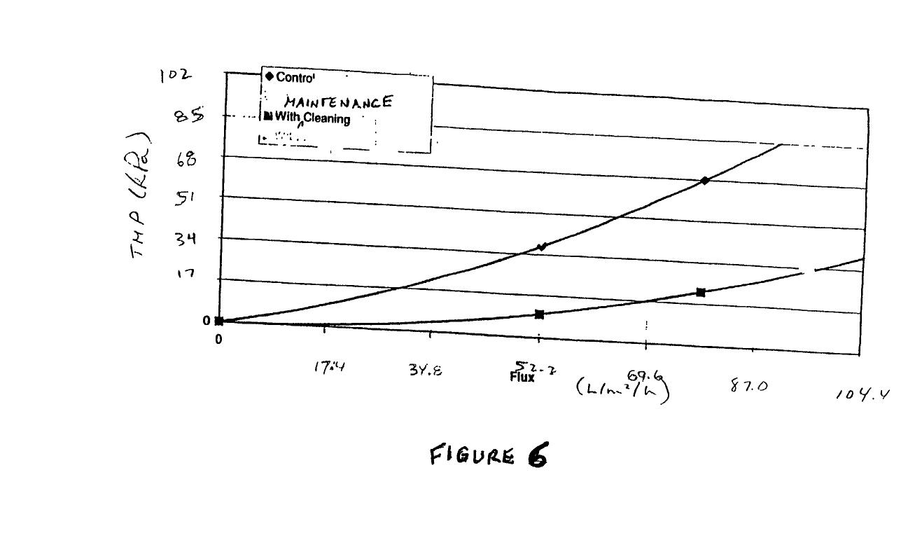

A small membrane module of horizontal hollow fiber membranes having approximately 28 m² of surface area was backwashed with 10-20 ppm chlorine for three minutes every two hours. The chemical backwash was started at the same time as the tank drains were opened but, because of the size of the tank, draining the tank finished before the chemical backwashing finished. The feed water was from a lake and had a pH of 7.5, a temperature of 20 C, turbidity of 10-15 ntu and TOC of about 5-8 mg/L. The process was run for over 30 days at a 95% recovery rate at two different permeate fluxes −20 L/m²/h and 30 L/m²/h. In both cases, acceptable permeability was maintained over extended periods of time. FIG. 5 shows the permeability of the membranes over time at each permeate flux.

### EXAMPLE 2

A membrane module of horizontal hollow fiber membranes was backwashed with 25 ppm chlorine for 10 minutes once per day. The chemical backwash was performed substantially while draining the tank except that a first pulse of 2 minutes duration was performed with the tank full. Subsequent pulses (8 per cleaning event) were 15 seconds in duration separated by 45 second periods in which chemical cleaner was not delivered to the membranes. The feed water had a temperature of 25 C, turbidity of 1-5 ntu and TOC of about 2-5 ppm. The process was run for over 30 days at between 90% an d 95% recovery rate at a permeate fluxes of 30 L/m²/h. Measured permeability (at 20C) was between about 145 and 165 L/m²/h/bar for over 30 days and indicated a drop in permeability of only between 5 and 10 L/m²/h/bar over the duration of the test. In both cases, acceptable permeability was maintained over extended periods of time.

### EXAMPLE 3

An experimental membrane bioreactor using a ZEEWEED 500 membrane module having 46 square meters of membrane surface area was built for treating waste water and, in particular, for carbon oxidation, nitrification and phosphorus removal. At all times, the flow rate of permeate through the membranes was maintained at 25.5 L/m²/h and the solids concentration in the bioreactor averaged between 15 g/l and 20 g/l. The average flow through the bioreactor was 1,000 cubic meters per day and the peak flow was 2,000 cubic meters/day.

The bioreactor was first operated without cleaning according to the invention for 90 days. Permeability was not sustainable and decreased continuously. At the end of this time, permeability of the membranes had dropped to less than 75 L/m2/h/bar.

The bioreactor was then operated with a fresh membrane module for 90 days with maintenance cleaning according to the present invention. The cleaning was performed twice per week using 100-125 mg/l NaOCl solution for one hour in pulses at a rate of 430 mg per square meter per week. The permeability of the membranes decreased slowly and eventually stabilised at about 187.5 L/m2/h/bar.

On an average basis, no significant decrease in effluent quality in terms of ammonia-nitrogen or total phosphorous occurred when cleaning according to the present invention was instituted. Concentration of cBOD5 in the effluent both with and without cleaning according to the present invention averaged 1.0 mg/l.

### EXAMPLE 4

An experimental membrane bioreactor using ZEEWEED 10 membrane modules having 0.9 square meters of membrane surface area each was built for treating lake water to produce potable water. All experiments were performed at constant flux in which the flow is kept constant and the transmembrane pressure (TMP) was allowed to increase as membranes fouled. The raw water conditions were as follows:

| | |
|---|---|
| Temperature (C.) | 10-20 |
| TOC (mg/l) | 3.0-5.0 |
| Turbidity (ntu) | 4.0-9.0 |
| Apparent Colour (Pt Co units) | 10-50 |
| True Colour (Pt Co units) | 5.0-20.0 |

Experiments were performed with and without maintenance cleaning and at different fluxes. Cleaning events were done three times per week with 100 mg/l NaOCI for 30 minutes. The cleaning dosage was between 320 and 430 mg NaOCI per square meter of membrane per week.

FIG. 6 summarises the results obtained with and without maintenance cleaning. Each test lasted about 45-60 days. After an initial increase in TMP, the TMP reached a relatively constant value which is referred to as the sustainable TMP. Sustainable TMP is plotted as a function of fixed operating flux. Permeability can be calculated by dividing the operating flux by TMP. In this figure, the “control” condition refers to operation without maintenance cleaning. Substantial improvement in sustainable TMP was obtained using maintenance cleaning.

The residual chlorine concentration in the process tank after each cleaning event was less than 0.5 mg/l. This level of residual chlorine in the process tank was low enough to continue the filtration process to produce potable water.

It is to be understood that what has been described are preferred embodiments to the invention. The invention nonetheless is susceptible to changes and alternative embodiments without departing from the invention, the scope of which is defined in the following claims.

We claim:

1. A method for cleaning one or more membranes normally immersed in a water containing solids in a tank and used to produce a permeate comprising:
performing cleaning events having the steps of:
(a) stopping permeation;
(b) flowing a selected concentration of a chemical cleaner through the membranes in a direction opposite to the direction in which permeate passes through the membranes, while the membranes remain immersed in the water containing solids, in repeated pulses followed by waiting periods, the repeated pulses and waiting periods in a cleaning event cumulatively having a selected duration; and,
(c) resuming permeation;
wherein the membranes are not agitated while the chemical cleaner is flowed through the membranes.

2. The method of claim 1 repeated at least once per week.

3. The method of claim 2 wherein the product of the concentration of the chemical cleaner expressed as an equivalent concentration of NaOCl in cleaning efficacy and the duration of the pulses and waiting periods in a week is between 2,000 minutes·mg/L and 30,000 minutes·mg/L.

4. The method of claim 3 wherein the product of the concentration of the chemical cleaner expressed as an equivalent concentration of NaOCl in cleaning efficacy and the duration of the pulses and waiting periods in a week is between 2,000 minutes·mg/L and 20,000 minutes·mg/L.

5. The method of claim 2 wherein the water lean in solids is intended for drinking water and the product of the concentration of the chemical cleaner expressed as an equivalent concentration of NaOCl in cleaning efficacy and the duration of the pulses and waiting periods in a week is between 5,000 minutes·mg/L and 10,000 minutes·mg/L.

6. The method of claim 2 wherein the water rich in solids is a wastewater and the product of the concentration of the chemical cleaner expressed as an equivalent concentration of NaOCl in cleaning efficacy and the duration of the pulses and waiting periods in a week is between 10,000 minutes·mg/L and 30,000 minutes·mg/L.

7. The method of claim 1 wherein the pulses last for between 10 seconds and 100 seconds and the waiting periods last for between 50 seconds and 6 minutes.

8. The method of claim 1 wherein the pulses last for between 10 seconds and 100 seconds and the waiting periods last for between 50 seconds and 3 minutes.

9. The method of claim 1 wherein the length of th e pulses is selected to provide chemical cleaner in an area in and adjacent to the membranes with an initial efficacy and the length of the waiting periods is selected to provide substantially effective chemical cleaner in an area in and adjacent to the membranes during the waiting period.

10. The method of claim 1 wherein the membranes are hollow fiber membranes and the pressure of the pulses is between 5 kPa and 55 kPa above the pressure on the outside of the membranes.

11. The method of claim 10 wherein the flow through the membranes during the pulses is between 8.5 and 51 L/m²/h/bar.

12. The method of claim 1 wherein chemical cleaner is removed from the tank as retentate before permeation is resumed.

13. The method of claim 12 wherein substantially all of the chemical cleaner removed from the tank as retentate before permeation is resumed.

14. The method of claim 1 wherein a permeate pump is used to flow the selected concentration of cleaning chemical through the membranes.

15. A method for cleaning one or more membranes immersed in water rich in solids and used to permeate a water lean in solids wherein each cleaning event comprises the steps of:
(a) stopping permeation and agitation of the water containing solids;
(b) flowing a chemical cleaner through the membranes in a direction opposite to the direction in which permeate passes through the membrane;
(c) resuming permeation; and,
(d) resuming agitation,
and wherein permeate collected before resuming agitation is wasted or recycled to the water containing solids and wherein the membranes and the membranes remain immersed during steps (a), (b), (c) and (d).

16. A method for cleaning one or more filtering membranes normally immersed in tank water containing solids in a tank and used to produce a permeate in one or more cleaning events, each cleaning event comprising the steps of:
(a) stopping permeation;
(b) draining the tank water from the tank to below the level of the membranes; and,
(c) flowing a chemical cleaner in pulses through the membranes in a direction opposite to the direction in which water lean in solids normally permeates through the membranes; and,
(d) refilling the tank,
wherein,
(e) the cleaning events are performed at least once a week; and,
(f) the product of the concentration of the chemical cleaner expressed as an equivalent concentration of NaOCl in cleaning efficacy and the duration of all cleaning events in a week is between 2,000 minutes*mg/L and 20,000 minutes*mg/L.

17. The invention of claim 16 wherein the pulses have a pressure which minimizes the relative size of local pressure variations between membranes or portions of membranes in different parts of the tank.

18. The invention of claim 16 wherein the pulses have a pressure between 10 kPa and 55 kPa.

19. The invention of claim 16 wherein the membranes are vertically oriented hollow fibers fluidly connected to at least an upper header and the chemical cleaner flows into the membranes only through the upper header.

20. The invention of claim 19 wherein the pulses have a pressure between 10 kPa and 55 kPa.

21. The invention of claim 20 wherein the flux of chemical cleaner through the membranes is between 30 and 55 L/m²/h/bar.

22. The invention of claim 16 wherein the time between pulses is insufficient to allow the membranes to dry substantially from an initial wetted state and the duration of the flow of chemical cleaner in the pulses allows the membranes to be re-wetted to the initial state.

23. The invention of claim 22 wherein in each pulse the chemical cleaner flows for between 10 seconds and 120 seconds and does not flow for between 30 seconds and five minutes.

24. The invention of claim 16 wherein the flow of chemical cleaner is provided by a pump and the speed of the pump is controlled to maintain a preselected pressure of the pulses.

25. The invention of claim 23 wherein the time during which the pump is on in each pulse is decreased if the flux of the chemical cleaner increases from an initial value.

26. A process for filtering water containing solids with membranes in a tank comprising the steps of:
a) filling the tank with a feed water to be filtered to immerse the membranes;
b) creating a transmembrane pressure between a permeate side and a retentate side of the membranes, the retentate side of the membranes being in contact with the water in the tank, the permeate side being fluidly connected to a filtered permeate outlet, to generate a filtered permeate at the permeate outlet;
c) aerating the membranes to dislodge solids from the membranes;
d) backwashing the membranes;
e) draining the tank; and,
f) performing the steps above in repeated cycles
wherein the steps of backwashing the membranes and draining the tank may be performed either before the other or partially or substantially simultaneously and the step of backwashing the membranes in the repeated cycles periodically involves backwashing with a cleaning chemical having a selected concentration for a selected duration.

27. The invention of claim 26 wherein the step of backwashing the membranes in the repeated cycles involves backwashing with a cleaning chemical having a selected concentration between once a day and once a cycle.

28. The invention of claim 26 wherein the sum of the products of the concentration of the cleaning chemical and the duration of the steps of backwashing with a cleaning chemical performed in a week is selected to maintain an acceptable permeability of the membranes or to reduce the rate of decline in permeability of the membranes over extended periods of time.

29. The invention of claim 26 wherein the sum of the products of the concentration of the cleaning chemical and the duration of the steps of backwashing with a cleaning chemical performed in a week is between 2,000 min·mg/l and 20,000 min·mg/l when NaOCl is the cleaning chemical or an equivalent product of concentration and time of another cleaning chemical.

30. The invention of claim 29 wherein the sum of the products of the concentration of the cleaning chemical and the duration of the steps of backwashing with a cleaning chemical performed in a week is between 5,000 min·mg/l and 10,000 min·mg/l when NaOCl is the cleaning chemical or an equivalent product of concentration and time of another cleaning chemical.
